(19) United States
(12) Patent Application Publication
(10) Pub. No.: US 2020/0160315 A1
(43) Pub. Date: May 21, 2020

(54) AUTONOMOUS VEHICLE SMART PARKING TICKET

(71) Applicant: Cubic Corporation, San Diego, CA (US)

(72) Inventors: Gavin Smith, Crawley (GB); Marina Montalban, London (GB)

(73) Assignee: Cubic Corporation, San Diego, CA (US)

(21) Appl. No.: 16/680,961

(22) Filed: Nov. 12, 2019

Related U.S. Application Data
(60) Provisional application No. 62/768,773, filed on Nov. 16, 2018.

(51) Int. Cl. G06Q 20/32; G06F 16/25; G08G 1/14

(52) U.S. Cl. CPC G06Q 20/322; G08G 1/146; G06F 16/252

(57) ABSTRACT

An exemplary method may include receiving a parking space request to locate a nearby parking space for a CAV, searching, based on a location of the CAV, nearby parking facilities, locating at least a parking space, and sending the CAV to journey to the parking space. The method may also include receiving a request for payment of a parking ticket to be issued to a CAV for parking at the parking space, and determining an amount of payment for the requested parking ticket. The method may further include accessing a first account associated with the CAV and a second account associated with the parking facility where the CAV is parked, and conducting a transfer of value from the first account to the second account. The method may further include sending ticket payment information to the CAV. An exemplary parking system server may be configured to perform the exemplary method.

### CROSS-REFERENCES TO RELATED APPLICATIONS

This application claims the benefit of U.S. Provisional Patent Application No. 62/768,773, filed Nov. 16, 2018, entitled “Autonomous Vehicle Smart Parking Ticket,” which is assigned to the assignee hereof and incorporated by reference herein in its entirety.

### BACKGROUND

Connected and autonomous vehicles (CAVs) will not only be able to drive passengers to and from destinations, but can also park themselves when not in use. This can be particularly helpful where limited parking is available during times when a CAV is not in use. However, CAVs are unable to access a parking ticket kiosk to purchase a parking ticket for a parking space (e.g., for street parking, parking garages, parking lots (car parks), etc.).

### BRIEF SUMMARY

Embodiments of the invention(s) described herein below address these and other concerns by providing a system whereby a CAV may communicate with a parking system server and/or other entities to find a parking space, pay for parking, and/or display and/or transmit proof of payment to a traffic warden.

Embodiments of present technology may include a method of providing a parking ticket to a connected and autonomous vehicle (CAV). In some embodiments, the method may include receiving a parking space request to locate a nearby parking space for a CAV. The parking space request may include information indicative of a location of the CAV. The method may also include searching, based at least in part on the information indicative of the location of the CAV, a database containing information regarding nearby parking facilities having parking spaces, and locating at least one available parking space at at least one of the nearby parking facilities. The method may further include sending the CAV to journey to one parking space of the at least one available parking space.

In some embodiments, the method may further include receiving a request for payment of a parking ticket to be issued to the CAV for parking at the one parking space, and determining an amount of payment for the requested parking ticket. The method may also include accessing a first account associated with the CAV and a second account associated with the parking facility having the one parking space where the CAV may be parked, and conducting a transfer of value from the first account to the second account. The method may further include sending ticket payment information to the CAV.

In some embodiments, sending ticket payment information to the CAV further may include sending an encrypted message to the CAV. The encrypted message may include the ticket payment information. The method may further include providing an encryption key to the CAV.

In some embodiments, the method may further include determining a length of parking time based on one or more of the following: accessing parking rules governing a time limit for a parking space of the parking facility; receiving from the CAV or a device of a passenger or owner of the CAV an indication of a duration of parking; or accessing a schedule for the CAV maintained by a taxi service or a fleet owner.

In some embodiments, receiving the request for payment for the parking ticket may include: receive a first indication from the CAV that the CAV has entered the parking facility; track a length of time that the CAV has parked at the parking facility; and receive a second indication from the CAV that the CAV may be leaving the parking facility. In some embodiments, determining the amount of payment for the requested parking ticket may include determining the amount of payment for the requested parking ticket based at least in part on the tracked length of time.

In some embodiments, locating the at least one available parking space may include communicating with a computer system operated by a provider of the at least one of the parking facilities. The computer system may be configured to maintain information of available parking spaces. In some embodiments, locating the at least one available parking space may include receiving information regarding available parking spaces from a plurality of CAVs configured to detect available parking spaces.

In some embodiments, the method may further include sending information regarding the located at least one available parking space to a device of a passenger or owner of the CAV. The method may also include receiving, from the device of the passenger or owner of the CAV, a selection of a parking space from the at least one available parking space or a confirmation of the at least one available parking space by the passenger or owner. In some embodiments, sending the CAV to journey to the one parking space may include sending the CAV to journey to the parking space selected or confirmed by the passenger or owner.

In some embodiments, the method may further include receiving an indication of a level of tolerance for crime provided by a passenger or owner of the CAV, and determining a weight or importance of crime based on the indication received from the passenger or owner of the CAV. The method may also include accessing a database with crime statistics for locations relevant to the nearby parking facilities. The at least one available parking space may be located based on at least one of the crime statistics or the weight or importance of crime.

In some embodiments, the method may further include assigning the at least one available parking space to the CAV. The method may also include communicating to other CAVs the assignment of the at least one available parking space to the CAV. In some embodiments, conducting the transfer of value may include sending a request to a server requesting a transfer of value from the first account to the second account, and receiving from the server a confirmation of the transfer of value.

Embodiments of the present technology may include a parking system server. In some embodiments, the parking service server may include a communication interface, a memory, and a processing unit communicatively coupled with the memory and the communication interface. The processing unit may be configured to cause the parking service server to receive a parking space request to locate a nearby parking space for a CAV. The parking space request may include information indicative of a location of the CAV. The processing unit may also be configured to cause the parking service server to search, based on the information indicative of the location of the CAV, information regarding nearby parking facilities having parking spaces, and locate at least one available parking space at at least one of the nearby parking facilities. The processing unit may further be configured to cause the parking service server to send the CAV to journey to one parking space of the at least one available parking space.

In some embodiments, the processing unit may be configured to further cause the parking service server to receive a request for payment of a parking ticket to be issued to the CAV for parking at the one parking space, and determine an amount of payment for the requested parking ticket. The processing unit may also be configured to cause the parking service server to access a first account associated with the CAV and a second account associated with the parking facility having the one parking space where the CAV may be parked, and conduct a transfer of value from the first account to the second account. The processing unit may be configured to further cause the parking service server to send ticket payment information to the CAV.

In some embodiments, the processing unit may be further configured to cause the parking service server to send ticket payment information to the CAV by: sending an encrypted message including the ticket payment information to the CAV, and/or providing an encryption key to the CAV.

In some embodiments, the processing unit may be further configured to determine a length of parking time based on one or more of the following: accessing parking rules governing a time limit for a parking space of the parking facility; receiving from the CAV and/or a device of a passenger or owner of the CAV an indication of a duration of parking; or accessing a schedule for the CAV maintained by a taxi service or a fleet owner.

In some embodiments, the processing unit may be configured to cause the parking service server to receive the request for payment for the parking ticket for the CAV by causing the parking service server to: receive a first indication from the CAV that the CAV has entered the parking facility; track a length of time that the CAV has parked at the parking facility; and receive a second indication from the CAV that the CAV may be leaving the parking facility. In some embodiments, the processing unit may be configured to cause the parking service server to determine the amount of payment for the requested parking ticket based at least in part on the tracked length of time.

In some embodiments, the processing unit may be further configured to cause the parking service server to locate the at least one available parking space by communicating with a computer system operated by the at least one of the parking facilities. The computer system may be configured to maintain information of available parking spaces. In some embodiments, the processing unit may be further configured to cause the parking service server to locate the at least one available parking space by receiving information regarding available parking spaces from a plurality of CAVs configured to detect available parking spaces.

In some embodiments, the processing unit may be configured to cause the parking service server to send information regarding the located at least one available parking space to a device of a passenger or owner of the CAV. The processing unit may be configured to further cause the parking service server to receive, from the device of the passenger or owner of the CAV, a selection of a parking space from the at least one available parking space or a confirmation of the at least one available parking space by the passenger or owner. Sending the CAV to journey to the one parking space may include sending the CAV to journey to the parking space selected or confirmed by the passenger or owner.

In some embodiments, the processing unit may be configured to cause the parking service server to receive an indication of a level of tolerance for crime provided by a passenger or owner of the CAV, and determine a weight or importance of crime based on the indication received from the passenger or owner of the CAV. The processing unit may be configured to further cause the parking service server to access a database with crime statistics for locations relevant to the nearby parking facilities, and locate the at least one available parking space based on at least one of the crime statistics or the weight or importance of crime.

In some embodiments, the processing unit may be configured to cause the parking service server to assign the at least one available parking space to the CAV, and communicate to other CAVs the assignment of the at least one available parking space to the CAV. In some embodiments, the processing unit may be configured to cause the parking service server to conduct a transfer of value from the first account to the second account by: sending a request to a server requesting a transfer of value from the first account to the second account, and receiving from the server a confirmation of the transfer of value.

Embodiments of present technology may include a method of authenticating a parking ticket. In some embodiments, the method may include receiving parking ticket information via wireless beacons broadcast by a smart parking ticket incorporated in a connected and autonomous vehicle (CAV). In some embodiments, the method may also include sending the received parking ticket information to a parking system server for authentication. The parking ticket information may include at least one of identification information of the CAV, amount paid, time of purchase, and/or duration of parking. The method may further include receiving a result of authentication from the parking system server, and displaying the result of authentication.

In some embodiments, the parking ticket information may be received via Bluetooth low energy (BLE) beacons. In some embodiments, the method may also include receiving an encryption key from the parking service server for the parking ticket information received from the smart parking ticket.

In some embodiments, the method may also include communicating to the smart parking ticket to request a display of the smart parking ticket to be turned on to display visual information related to the parking ticket information. In some embodiments, the visual information may include a scannable code. The method may also include scanning the scannable code to obtain at least one of the parking ticket information or a link to a payment account.

In some embodiments, the result of authentication may indicate that the parking ticket information may be unauthenticated. The method may further include sending a request for payment to the parking service server. The request for payment may include at least one of identification information of the CAV or an amount of payment to request. The method may also include receiving from the parking system server an acknowledgment that the request for payment has been processed.

Embodiments of the present technology may include a device for authenticating a parking ticket. In some embodiments, the device may include a communication interface, a display, a memory, and a processing unit communicatively coupled with the communication interface, the display, and the memory. The processing unit may be configured to cause the communication interface to receive parking ticket information via wireless beacons broadcast by a smart parking ticket incorporated in a CAV, and to send the received parking ticket information to a parking system server for authentication. The parking ticket information may include at least one of identification information of the CAV, amount paid, time of purchase, or duration of parking. The processing unit may be configured to cause the communication interface to receive a result of authentication from the parking system server. The processing unit may be configured to cause the display to display the result of authentication.

In some embodiments, the processing unit may be configured to cause the communication interface to receive the parking ticket information via Bluetooth low energy (BLE) beacons. In some embodiments, the processing unit may be configured to cause the communication interface to receive an encryption key from the parking service server for the parking ticket information received from the smart parking ticket.

In some embodiments, the processing unit may be configured to cause the communication interface to communicate to the smart parking ticket to request a display of the smart parking ticket to be turned on to display visual information related to the parking ticket information. In some embodiments, the device may further include a camera communicatively coupled with the processing unit. The visual information may include a scannable code. The processing unit may be configured to cause the camera to scan the scannable code to obtain the parking ticket information.

In some embodiments, the result of authentication may indicate an unauthenticated purchase. The processing unit may be further configured to cause the communication interface to send a request for payment to the parking service server. The request for payment may include at least one of identification information of the CAV or an amount of payment to request. The processing unit may be further configured to cause the communication interface to receive from the parking system server an acknowledgment that the request for payment has been processed.

Embodiments of the present technology may include a smart parking ticket incorporated in a CAV. In some embodiments, the smart parking ticket may include a communication interface, a display, a memory, and a processing unit communicatively coupled with the memory, the communication interface, and the display. In some embodiments, the communication interface may be configured to receive parking ticket information from a parking service server, and broadcast proof of payment for parking via wireless beacons. In some embodiments, the display may be configured to provide visual information indicating the proof of payment for parking.

In some embodiments, the communication interface may be further configured to broadcast the proof of payment for parking via Bluetooth low energy (BLE) beacons. In some embodiments, the parking ticket information received from the parking service server may include an encryption key. In some embodiments, the communication interface may be further configured to broadcast the proof of payment for parking by broadcasting an encrypted message encrypted using the encryption key.

In some embodiments, the communication interface may be further configured to receive from a device operated by a traffic ward a request to provide proof of payment. The display may be further configured to, upon receipt of the request, display the visual information indicating the proof of payment. In some embodiments, the visual information may include a scannable code.

In some embodiments, the processing unit may be further configured to cause the communication interface to broadcast identification information about at least one of the CAV or a passenger or owner of the CAV. In some embodiments, the processing unit may be further configured to cause the display to provide visual information related to the identification information about the at least one of the CAV or a passenger or owner of the CAV.

In some embodiments, the processing unit may be further configured to cause the communication interface to receive a signal from the parking service server indicative of a length of time that the CAV has parked at the parking facility. The processing unit may be further configured to cause the display to provide visual information indicative of the length of time that the CAV has been parked based on the received signal.

### BRIEF DESCRIPTION OF THE DRAWINGS

For a more complete understanding of this invention, reference is now made to the following detailed description of the embodiments as illustrated in the accompanying drawings, in which like reference designations represent like features throughout the several views and wherein:

FIG. 1 is a simplified illustration of a CAV parking system, according to an embodiment.

FIG. 2 is a swim-lane diagram illustrating a process of sending a CAV to a parking space, according to an embodiment.

FIG. 3 is a swim-lane diagram illustrating a process of obtaining or buying a parking ticket for a CAV, according to an embodiment.

FIG. 4 is a swim-lane diagram illustrating how a traffic warden may check parking ticket information, according to an embodiment.

FIG. 5 is a swim-lane diagram illustrating how a traffic warden may request parking payment, according to an embodiment.

FIG. 6 is a simplified block diagram of a computer system, according an embodiment.

FIG. 7 is a flow diagram of a method of locating a parking space for a CAV, according to an embodiment.

FIG. 8 is a flow diagram of a method of providing a parking ticket to a CAV, according to an embodiment.

FIG. 9 is a flow diagram of a method of authenticating a parking ticket, according to an embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any or all of the similar components having the same first reference label irrespective of the second reference label.

### DETAILED DESCRIPTION

The ensuing description provides embodiments only, and is not intended to limit the scope, applicability or configuration of the disclosure. Rather, the ensuing description of the embodiments will provide those skilled in the art with an enabling description for implementing an embodiment. It is understood that various changes may be made in the function and arrangement of elements without departing from the scope.

Embodiments of the invention(s) described herein are generally related to systems and methods for an on-vehicle device that enables CAVs to find a parking space, pay for parking, and/or display and/or transmit payment to a traffic warden. That said, a person of ordinary skill in the art will understand that alternative embodiments may vary from the embodiments discussed herein, and alternative applications may exist.

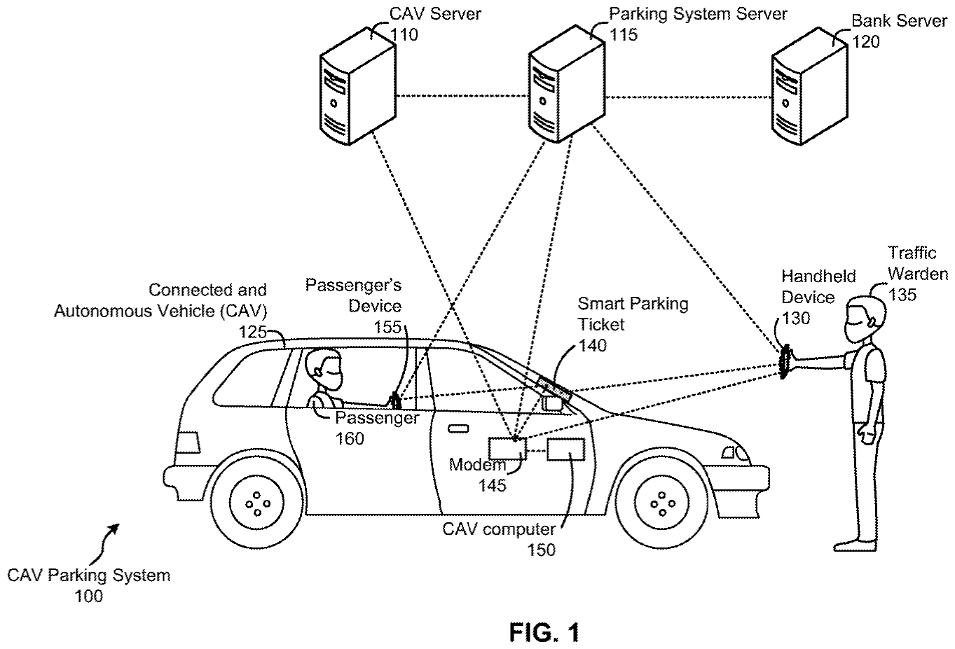

FIG. 1 is a simplified illustration of a CAV parking system 100, according to an embodiment. The CAV parking system 100 here may include a CAV server 110, a parking system server 115, a bank server 120, a CAV 125, and a handheld device 130 (used by a traffic warden 135). Additional devices included in the CAV 125 may include a smart parking ticket 140, a modem 145, and a CAV computer 150. A passenger's device 155 (operated by a passenger 160) may also be in communication with various components of the CAV parking system 100, as illustrated. In FIG. 1, dotted lines illustrate communication links between the various illustrated electronic devices. As such, communication may occur through various types of communication systems (not shown), including a wireless wide area network (WWAN) (e.g., a cellular network), wireless local area network (WLAN), any of a variety of public and/or private communication networks, including the Internet. Moreover, communication may utilize any of a variety of wireless and/or wired technologies, including Bluetooth, IEEE 802.11 (including Wi-Fi), IEEE 802.15.4 (including Zigbee), WiMAX™, cellular communication, etc.

A person of ordinary skill in the art will appreciate that FIG. 1 is a simplified illustration, to avoid clutter. Embodiments may vary in any of a variety of ways, including having a plurality of any of the components illustrated in FIG. 1. In some embodiments, for example, there may be dozens, hundreds, thousands, or more CAVs 125, passenger devices 155, handheld devices 130, and the like. Additionally or alternatively, embodiments may have a plurality of any or all of the servers 110, 115, and 120. Embodiments may additionally or alternatively combine or separate components, as needed. For example, in some embodiments, the CAV computer 150 may incorporate the modem 145.

The CAV 125 may be controlled by the CAV computer 150, and may be owned by the passenger 160, shared between various private individuals or entities, or may be owned and/or operated by a taxi service, vehicle-sharing service provider, or the like. The CAV computer 150 may control the various systems in the CAV 125 to provide autonomous driving and other functions. Autonomous driving, including communicating with other CAVs, may be facilitated by information provided by the CAV server 110 and/or other systems.

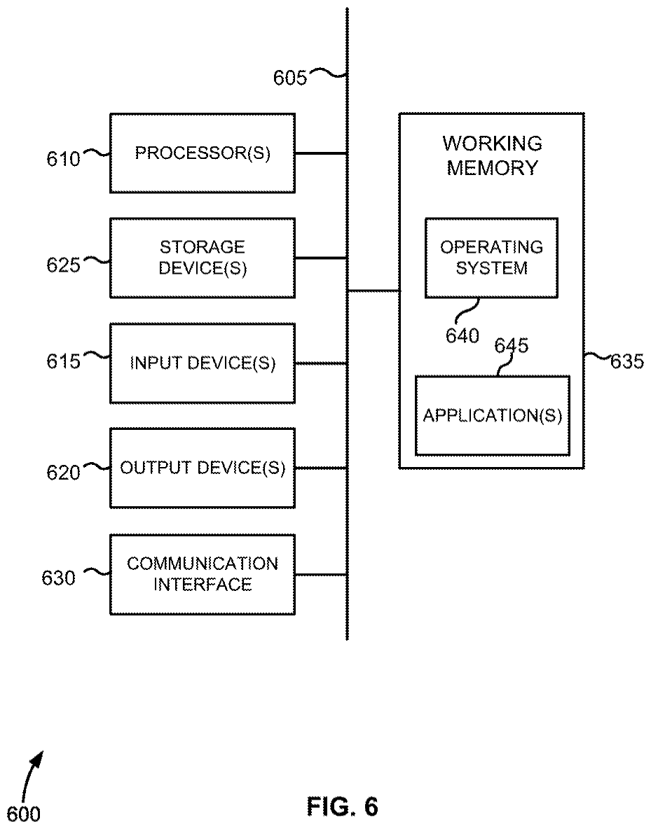

In some embodiments, the smart parking ticket 140 may be or may include a device that can be located on the dashboard (or elsewhere in or on the CAV 125) to provide proof of payment for parking. Accordingly, as used herein, the term “ticket” is meant to describe proof of payment for parking, as opposed to a “parking ticket” (e.g., issued by an officer) imposing a fine for improper parking. The smart parking ticket 140 may be integrated into the CAV 125, or may be a separate device, and may provide proof of payment in any of a variety of ways. For example, the smart parking ticket 140 may include a display, e.g., e-paper, liquid crystal display (LCD), light emitting diode (LED) display, etc., capable of providing a scannable code, such as a quick response (QR) code, and/or other visual information indicating proof of payment, which may reflect what would typically be shown on a traditional paper parking ticket. Additionally or alternatively, the smart parking ticket 140 may be able to provide proof of payment information via wireless beacons, e.g., Bluetooth low energy (BLE) beacons. In some embodiments, for example, the smart parking ticket 140 may provide an encrypted message via wireless beacons that the handheld device 130 can use to verify the authenticity of the information shown on the display of the smart parking ticket 140. Thus, the smart parking ticket 140 may therefore include a display, a communication interface, and/or other components of a computing device, such as the computing device 600 illustrated in FIG. 6 and described herein below.

The handheld device 130 may be operated by a traffic warden 135 to determine whether the CAV 125 is properly parked. The handheld device may include, for example, a ruggedized personal data assistant (PDA), smart phone, tablet, or other portable device, which may be able to communicate with the parking system server 115, e.g., via a cellular or Wi-Fi network. The handheld device 130 may therefore comprise a display, a wireless modem, a camera, and/or other components of a computing device, such as the computing device 600 illustrated in FIG. 6 and described herein below.

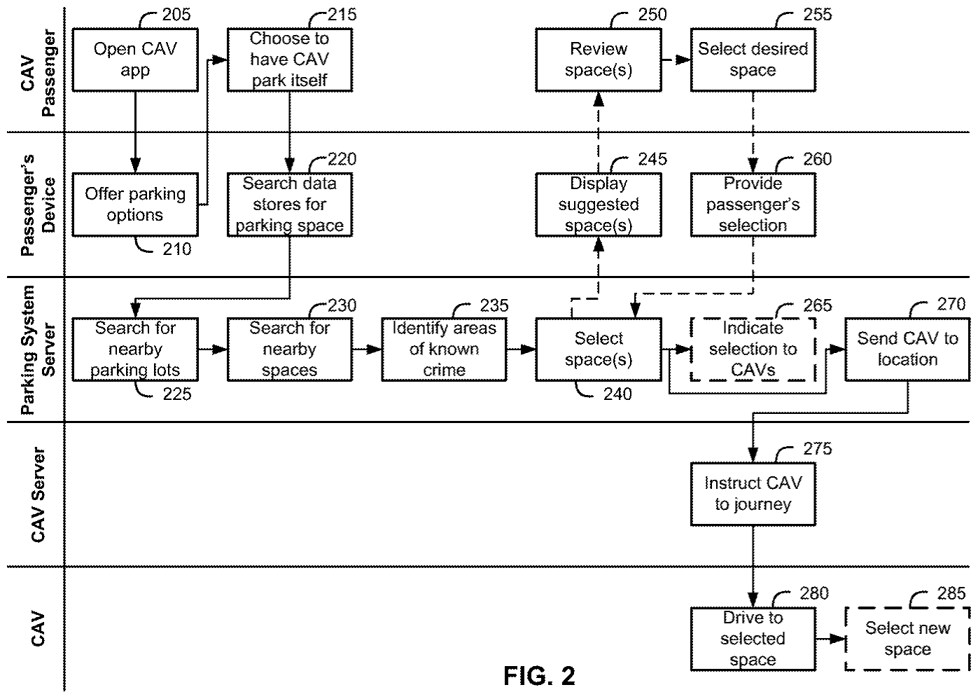

The CAV server 110 may be a server enabling communication between the CAV 125 and other CAVs, a parking system (e.g., parking system server 115), traffic systems, emergency systems, etc. As such, the CAV server 110 may be operated by a CAV manufacturer, government agency, pseudo-government agency, or the like. It can be noted that, in some embodiments, the CAV parking system 100 may not include a CAV server 110. In such embodiments, rather than having a CAV server 110 act as an intermediary between the parking system server 115 and the CAV 125 (as illustrated in the embodiments described in FIGS. 2-5) the parking system server 115 may communicate directly with the CAV 125.

The parking system server 115 may be in communication with the smart parking ticket 140 via modem 145. The parking system server 115 may facilitate finding and paying for parking, as well as providing proof of payment, as described in the embodiments described below. It may be operated by an entity separate from the entities operating the CAV server 110 and bank server 120, such as an independent parking service provider. In some embodiments, the parking system server 115 may maintain or have access to a customer account (e.g., associated with the passenger 160 and/or CAV 125), which may have information about the customer, and may hold a value for parking payment. The parking system server 115 may additionally or alternatively conduct a transaction with the bank server 120 in order to collect payment for the CAV's parking. The parking system server 115 can separately provide proof of payment to the handheld device 130 of the traffic warden 135 to verify proof of payment (e.g., when the traffic warden 135 requests the verification via the handheld device 130).

When paying for parking, the parking system server 115 can receive a request for payment from the CAV 125. The parking system server 115 may additionally have information for the various parking facilities, e.g., parking garages, parking lots, and/or street parking, for which the CAV 125 may need to provide parking payment. This information can include various applicable rules and prices, e.g., when parking is available, any applicable time limits for parking, prices (which may vary based on time of day), etc., which may thereby enable the parking system server 115 to determine a proper payment for the requested parking ticket, to conduct a transaction to pay for it, then to provide the smart parking ticket 140 with the ticket information, which the smart parking ticket 140 can then display and/or otherwise provide to the handheld device 130, when requested or needed.

In some embodiments, payment may be made retroactively, based on a length of time the CAV 125 has parked at a parking space. For example, upon entering a parking lot or parking in a parking space, the CAV 125 may communicate with the parking system server 115 (via modem 145), declaring it has entered the lot or has parked, and the parking system server 115 can start a timer that tracks the length of time that the CAV 125 has parked. In some embodiments, this timer may be displayed by the smart parking ticket 140, so that a traffic warden 135 may determine how long the CAV 125 has parked. Upon leaving the parking lot or parking space, the CAV 125 can notify the parking system server 115, and the parking system server 115 can then conduct a transaction to pay for the parking, based on the length of time the CAV 125 was parked.

The swim-lane diagrams in the following FIGS. 2-5 help to further illustrate how the various components of the CAV parking system 100 can communicate to perform various functions, according to various embodiments.

FIG. 2 is a swim-lane diagram illustrating a process of sending the CAV 125 to a parking space, according to an embodiment. The process may be initiated, for example, when the CAV passenger 160 leaves the vehicle (e.g., upon leaving the CAV 125 once the CAV 125 has reached its destination). As with other figures herein, FIG. 2 is provided as a non-limiting example. Alternative embodiments may include additional or alternative functions, combine and/or separate the functionality illustrated in the blocks of FIG. 2, omit various functions (or make them optional), and/or vary from the illustrated embodiment in other ways.

At block 205, the CAV passenger 160 may open a CAV app on the passenger's device 155. The CAV app may include a software application executed by the passenger's device 155 (e.g., a personal electronic device, such as a smart phone, tablet, etc.). At block 210, the passenger's device 155 may offer parking options to the CAV passenger 160 (e.g., via a graphical user interface (GUI) on a display of the passenger's device 155), which may include an option (e.g., a selectable element, such as a button, on the device's touchscreen) to send or instruct the CAV 125 to park itself. At block 215, the CAV passenger 160 may select the option to have the CAV 125 to park itself. At block 220, the passenger's device 155 may search data stores for a parking space by communicating with the parking system server 115.

At block 225, the parking system server 115 may search for nearby parking lots. For example, when communicating with the parking system server 115, the passenger's device 155 may send information indicative of a location of the CAV 125. The parking system server 115 may have a database in which information regarding nearby parking (street parking, parking lots, etc.) may be stored. This database may be searched at block 225 to determine one or more parking lots, streets, etc., having available parking spaces.

At block 230, the parking system server 115 may search for nearby spaces 230 at the determined parking lots. In some embodiments, the parking system server 115 may not have direct access to information regarding a specific parking lot because, for example, the parking system server 115 may be operated by an entity separate from a computer system operated by a parking lot provider, which may track available parking spaces directly. Nonetheless, in some embodiments, the parking system server 115 may be configured to interface with such a computer system to gather information regarding available parking spaces.

Additionally or alternatively, information may be sourced from multiple CAVs. In some embodiments, multiple CAVs in communication with the parking system server 115 may detect various available parking spaces, and communicate the location of these available spaces to the parking system server 115. As such, the parking system server 115 may have information indicating which parking spaces are available. Further, in some embodiments, the parking system server 115 may effectively conduct a “virtual booking” of the parking space, among multiple CAVs, by assigning a parking space to a particular CAV 125 in communication with the parking system server 115, and preventing other CAVs in communication with the parking system server 150 from occupying the parking space (e.g., by communicating to the other CAVs that the parking space has been “virtually booked”).

At block 235, the parking system server 115 may identify areas of known crime, in which it may be undesirable to park the CAV 125. The parking system server 115 may keep a database, or access a database (e.g., database maintained by a law enforcement or other government entity), with crime statistics that may indicate crime levels at certain streets, parking lots, or other relevant locations to nearby parking. The parking system server 115 can then use that information to determine whether or not to park in a given parking space. In some embodiments, the CAV passenger 160 (or owner of the CAV 125) may indicate (e.g., via the parking application executed by the passenger's device 155) a level of tolerance for parking in such areas. That is, the parking system server 115 may determine a weight or importance of crime in a given area when determining a space in which to park the CAV 125.

At block 240, the parking system server 115 may select one or more parking spaces. In some embodiments, the parking system server 115 may simply select a parking space for the CAV 125. In some embodiments, an input from the CAV passenger 160 (or owner) may be desirable. As such, one or more available parking spaces identified at block 230 may be sent to the passenger's device 155. At block 245, the passenger's device 155 may display the suggested one or more spaces, allowing the CAV passenger 160 to review the one or more spaces at block 250, then select a desired space (or, if only one space is presented, confirm the parking space) at block 255. At block 260, the passenger's device 155 then receives the passenger's selection and provides it to the parking system server 155.

Once the parking space is determined, other CAVs may be alerted that the space has been “virtually booked,” as previously discussed. As such, the parking system server 115 can, at block 265, indicate the selection to other CAVs.

At block 270, the parking system server 115 may communicate with the CAV server 110 (or, directly with the CAV 125) to, at block 275, instruct the CAV 125 to journey to the parking space, which the CAV 125 does at block 280, ultimately parking at the space. Optionally, however, the CAV 125 may be capable of determining to select and park in a new parking space, as shown at block 285, if the new space is detected by the CAV 125 during its journey to the parking space selected by the parking system server 115. The CAV 125 may have a rule database or other logic for determining whether to select the new space or continue driving to the parking space selected by the parking system server 115, or may communicate with the parking system server 115 to determine whether the new space would be desirable to park in, in light of crime and/or other information available to the parking system server 115.

In some embodiments, the CAV may communicate with the parking system server 115 to confirm that the CAV 125 has parked in either the selected space or the new space. The CAV 125 (or parking system server 115) may additionally or alternatively communicate with the passenger's device 115, to notify the CAV passenger 160 that the CAV 125 has parked.

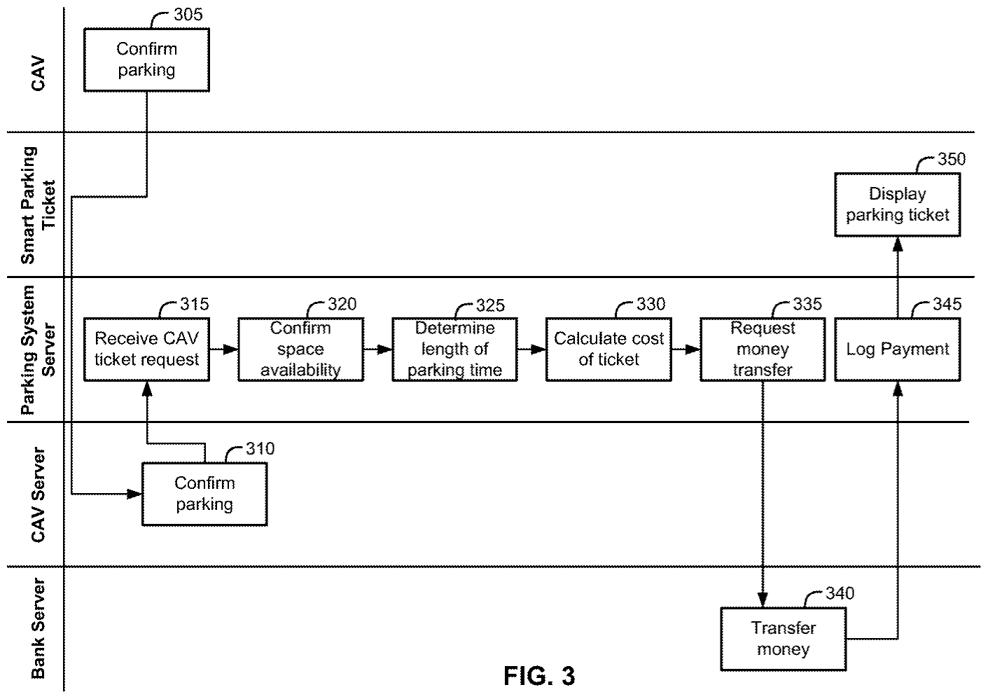

FIG. 3 is a swim-lane diagram illustrating a process of obtaining or buying a parking ticket for the CAV 125, according to an embodiment. Here, the relevant entities may include the CAV 125, the smart parking ticket 140, the parking system server 115, the CAV server 110, and/or the bank server 120. Again, alternative embodiments may vary from the functionality illustrated in FIG. 3 in any of a variety of ways. The functionality illustrated in FIG. 3 may begin once the CAV has parked in an available parking space and needs to obtain a parking ticket. Communication between the various entities illustrated in FIG. 3 may be encrypted, to help secure payment and/or ticket information.

At block 305, the CAV 125 may confirm that it has parked in a parking space by sending a message to the CAV server 110. At block 310, the CAV server 110 may relay confirmation of the parking to the parking system server 115. At block 315, the parking system server 115 may receive the confirmation as a ticket request for the CAV 125.

At block 320, the parking system server 115 can confirm space availability. That is, although the CAV 125 may gather parking information via other sources (e.g., via parking signs, etc.) to determine that a given parking space may be acceptable to park in, the parking system server 115 can access a rule database to determine whether rules governing parking for the particular parking space allow the CAV 125 to park there, and for how long. This rule database may be kept on the parking system server 115 and/or maintained on a separate server, which may be maintained by a separate entity (e.g., a parking lot provider), for example.

At block 325, the parking system server 115 can determine a length of time for the parking ticket. This can be based on a variety of information, depending on desired functionality. In addition to any parking rules that may govern a time limit for the parking space, for example, the CAV 125 may only need to occupy the space for a certain period of time. Where the CAV 125 belongs to a taxi service, for example, the parking system server 115 may access a database to obtain the schedule for the CAV 125 to determine a time the CAV 125 is scheduled to leave the parking space (e.g., based on bookings for the CAV 125). Again, this database may be separate from the parking system server 115, and may be maintained by a separate entity (e.g., an owner or operator of a CAV taxi service).

In some embodiments, the CAV 125 itself may have some indication of when it will leave the parking space, and may communicate that information to the parking system server 115. For example, the CAV 125 may track its parking history, such as in the case where the CAV 125 is taxi that may track the time it is not booked. Based on the parking history, it may predict how long it would be parked at the current parking space. For example, if the CAV 125 may have parked frequently for a certain duration during certain time of the day, the CAV 125 may determine to pay for the same amount of parking time at the same time of the day. In some embodiments, when there may not be sufficient history to predict the parking time needed, the CAV 125 may then pay for a short duration and then pay to extend the duration of parking, if needed. In some embodiments, the CAV 125 may be a personal vehicle, and the length of parking time may be obtained from passenger input, via the passenger's device 155. The passenger's device 155 may then communicate the passenger's input to the CAV 125 and/or to the parking system server 115. For example, the parking app executed by the passengers device 155 may enable a passenger 160 to input a length of time for parking.

At block 330, the parking system server 115 may calculate the cost of the ticket. In some embodiments, the parking system server 115 may calculate the cost of the ticket based on parking rules. As such, the parking system server 115 may again access a rule database to make this determination.

At block 335, the parking system server 115 can then request a money transfer from a payer account to a payee account. In some embodiments, for example, the owner of the CAV 125 (e.g., a passenger 160, taxi service, fleet owner, etc.) may set up an account with the parking system server 115 which may include payment information (e.g., a payment card number, expiration date, UTC, balance account, rewards/points account, and/or other credit or value for parking payment) used to pay for parking related to the CAV 125. The parking system server 115 may also have accounts for the various parking lot owners and/or other parking merchants, and may identify the particular account to which the payment should be made. The parking system server 115 can then provide the information of the payer and the information of the payee to the bank server 120 at block 340, which makes the payment for the parking by transferring the money from the payer's account, e.g., the customer's account, to the payee's account, e.g., the merchants account. In some embodiments, the parking service server 115 may conduct the transaction by transferring value from the account associated with the CAV 125 to the account associated with the parking lot owner and/or merchant by without interfacing with the bank server 120. For example, the account associated with the CAV 125 may include credits or rewards which may be deducted by the parking service server 115.

At block 345, the parking system server 115 may then, after receiving confirmation of the money transfer from the bank server 120, log the payment (e.g., in a parking payment database) and related parking information (e.g., parking starting and/or ending time, duration paid for, amount paid for, identification information of the CAV, etc.), and then send ticket payment information to the smart parking ticket 140. With this information, the smart parking ticket 140 can then display the parking ticket at block 350, and/or provide the proof of payment in an alternative manner (e.g., via radio frequency (RF) signals), as described herein.

Depending on desired functionality, the smart parking ticket 140 can display the parking ticket at block 350 in any of a variety of ways. As previously discussed, the smart parking ticket 140 may have a display (LCD, LED, e-ink, etc.) with which it may display ticket information that would be shown on a printed paper ticket. As such, in some embodiments, the display may be always on while the CAV 125 is parked. In other embodiments, the traffic warden 135 may be capable of causing the smart parking ticket 140 to turn on its display, based on a triggering event (e.g., the traffic warden 135 causing the handheld device 130 to communicate with the smart parking ticket 140, requesting the display to be turned on.).

Additionally or alternatively, the smart parking ticket 140 may send out RF beacons, e.g., Bluetooth low energy (BLE) beacons, with ticket information. This information may be encrypted to help ensure the ticket information remains secure. The handheld device 130 and the smart parking ticket 140 may obtain encryption keys from the parking system server 115.

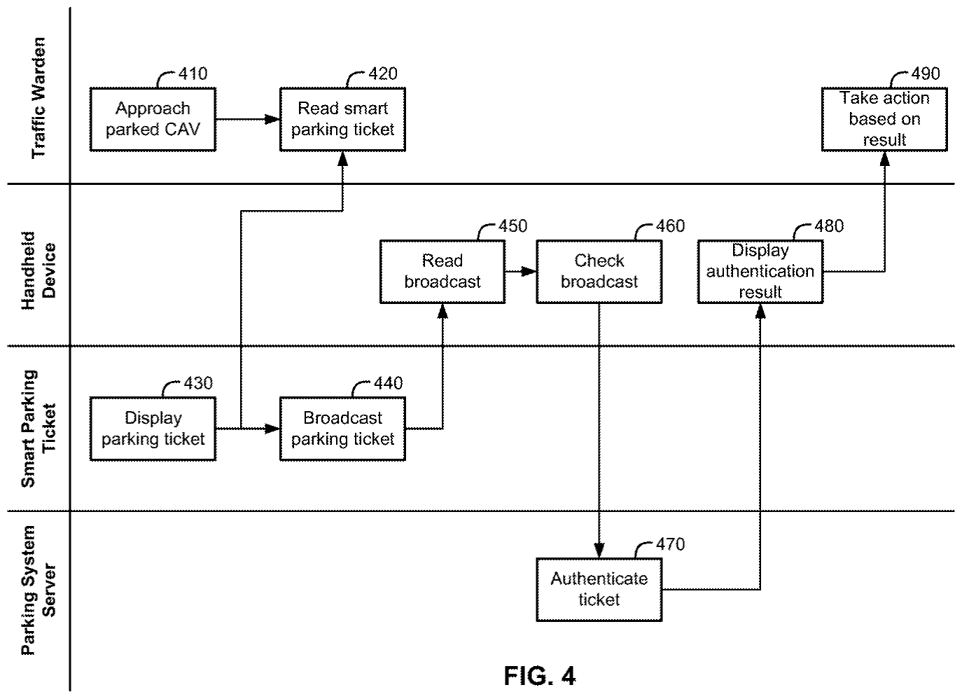

Embodiments that both display and transmit ticket information may provide an extra layer of security against fraud. For example, the traffic warden 135 may scan a QR code (or other ticket information) displayed by the smart parking ticket 140 using the handheld device 130, and may compare that with information received via RF beacons. The handheld device 130 may additionally be used to verify information received from the display and/or RF beacons with the parking system server 115, as illustrated in FIG. 4, and described in further detail below.

Ticket information displayed by the smart parking ticket 140 may vary, depending on desired functionality. Ticket information can include, for example, an identifier of the vehicle (a VIN number, a license plate number, and an account number, a unique identifier generated by the parking system server 115, etc.), a price paid, the time the ticket expires (or, if payment is due after parking, how much time has elapsed since the CAV 125 has parked and/or a time at which the CAV 125 parked), and/or other information that may be shown by parking tickets. In some embodiments, ticket information may additionally include a service provider of the parking system server 115. In some embodiments, the ticket information may be broadcast by RF beacons and/or encoded in a QR code that may be displayed by the smart parking ticket 140 and scanned by the handheld device 130. In some embodiments, the QR code and/or RF beacons may include additional identification information for the CAV 125, such as, make, model, color, etc., which may not be displayed elsewhere by the smart parking ticket 140.

In some embodiments, a traffic warden 135 may be able to create a request for payment by scanning a QR code on the smart parking ticket 140, which may be used as an identifier for the CAV 125, or obtaining an identifier of the CAV 125 via RF beacons. For example, in some instances (e.g., where connectivity is disrupted between various devices of the CAV parking system 100, when a parking ticket has expired, etc.), the CAV 125 may be unable to obtain a ticket. In such instances, and in other scenarios, the traffic warden 135 may initiate or generate a request for payment via the handheld device 130 by scanning the QR code (or using another identifier of the CAV 125) with the handheld device 130, which then sends the request for payment to the parking system server 115. The parking system server 115 may then conduct a transaction in a manner similar to that described above. In some embodiments, the traffic warden 135 may specify an amount for the payment.

In some embodiments, the QR code or RF beacons may also be used by emergency services to help identify the CAV 125 and/or passenger 160. That is, the parking system server 115 may be configured to communicate with emergency service equipment, which may be capable of scanning the smart parking ticket 140 in a manner similar to the handheld device 130 (e.g., using a camera), then send the identifier to the parking system server 115, with a request for information related to the CAV 125. The parking system server 115 may then respond by providing available information back to the emergency service equipment, such as a VIN number, license plate number, owner, destination (and/or other booking details), etc., related to the CAV 125. In some embodiments, the parking system server 115 may include additional information (e.g., emergency contact information, phone number, address, etc.), which may be provided to the parking system server 115 from the passenger 160 or owner of the CAV 125. In some embodiments, in the scenario where the CAV may be a taxi, the passenger information may also be provided to the taxi booking system. When the QR code may be scanned or the RF beacons may be received by the emergency service equipment, a link to the booking system may be obtained to obtain information regarding the passenger even if the passenger may be unconscious in the vehicle and cannot communicate.

FIG. 4 is a swim-lane diagram illustrating how a traffic warden 135 may check the information of the smart parking ticket 140, according to an embodiment. Here, the relevant interacting entities may include the traffic warden 135, the handheld device 130, the smart parking ticket 140, and the parking system server 115. In this embodiment, the smart parking ticket may both display parking ticket information on a display and broadcast parking ticket information via RF beacons (e.g., BLE beacons). However, as previously indicated, alternative embodiments may utilize only one of these methods for providing parking ticket information. Communication between the various entities illustrated in FIG. 4 may be encrypted, to help secure ticket information.

At block 410, the traffic warden 135 may approach the CAV 125 and read the smart parking ticket 140 at block 420. The smart parking ticket 140 may display parking ticket information at block 430. Here, the traffic warden 135 may scan a QR code displayed on the smart parking ticket 140 (which, as indicated above, may be used to identify the CAV 125) and/or manually read ticket information in the same manner a traditional paper ticket would be read. The smart parking ticket 140 may also broadcast the parking ticket information at block 440, which is received by the handheld device 130 at block 450.

At block 460, the handheld device 130 then checks the information broadcast by the smart parking ticket 140 by sending the information to the parking system server 115, which can then authenticate the ticket at block 470. Information sent from the handheld device 130 to the parking system server 115 can include parking ticket information such as a unique identifier of the CAV 125, any aspect of the parking ticket information (amount paid, time of purchase, duration of parking ticket, etc.), which the parking system server 115 can then verify.

At block 480, the handheld device 130 receives the results of the authentication by the parking system server 115 (e.g., either authenticating the ticket information, or indicating possible fraud and/or other potential issues), and displays them to the traffic warden 135. The traffic warden 135 can then take an action based on the results at block 490. If, for example, the ticket information is verified by the parking system server 115, the traffic warden 135 can then continue observing other parked cars. If, on the other hand, the ticket information indicates possible fraud, nonpayment, etc., the traffic warden 135 can then take appropriate action.

In some embodiments, authentication results displayed by the handheld device 135 at block 480 may indicate possible issues, as indicated above. In other embodiments, the authentication results may simply include ticket information, which the traffic warden 135 can then manually compare with information shown on the smart parking ticket 140 at block 430, to determine whether there are any issues with the parking ticket.

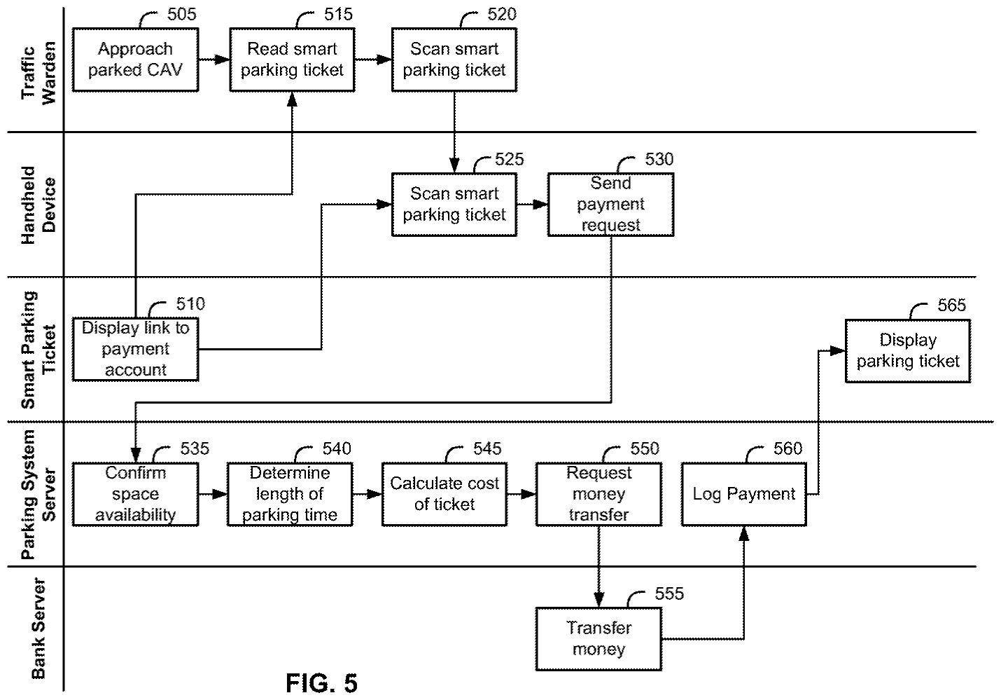

FIG. 5 is a swim-lane diagram illustrating how the traffic warden 135 may request parking payment, according to an embodiment. As previously indicated, there may be scenarios in which a payment may need to be made to pay for the parking of the CAV 125. This can occur, for example, if there is communication failure between certain components of the CAV parking system 100 at the time the CAV 125 is requesting to pay for parking. This can also occur after the ticket expires. Communication between the various entities illustrated in FIG. 5 may be encrypted, to help secure payment and/or ticket information.

A block 505, the traffic warden 135 approaches the CAV 125. The smart parking ticket 140 displays a link to a payment account (e.g., via a QR code) for the CAV 125 at block 510, which the traffic warden 135 then reads at block 515 and scans with the handheld device 130 at blocks 520 and 525. In some embodiments, the link to the payment account shown at block 510 may be the same as the parking ticket information displayed at block 430 of FIG. 4. That is, the ticket information may include identification information enabling a parking system server 115 to determine an account associated with the CAV 125. Additionally or alternatively, the handheld device 130 may obtain ticket information via a BLE or other RF beacon, as indicated elsewhere herein.

At block 530, the handheld device 130 may then send a request for payment to the parking system server 115. As previously indicated, the handheld device 130 may enable the traffic warden 135 to send the request, and may optionally include an amount to request. Once the payment request has been sent, the functionality for the smart parking ticket 140, parking system server 115, and bank server 120 at blocks 535-565 may echo the functionality of block 320-350 of FIG. 3, as described above. As such, once the smart parking ticket 140 displays the parking ticket at block 565, the traffic warden 135 can verify that the ticket has been paid. In some embodiments, the parking system server 115 may send one or more acknowledgments back to the handheld device 130. For example, the parking system server 115 may send an acknowledgment to the handheld device 130 upon receipt of the request for payment. In some embodiments, the parking system server 115 may also send an acknowledgment to the handheld device 130 once the payment request has been processed and/or logged.

FIG. 6 is a simplified block diagram of a computer system 600, according to an embodiment. A computer system 600 as illustrated in FIG. 6 may, for example, correspond with and/or be integrated into one or more components of a CAV parking system 100, including a CAV computer 150, handheld device 130, passenger's device 155, CAV server 110, parking system server 115, smart parking ticket 140, and/or bank server 120. Applicable software and/or applications may be included in the computer system 600. The software and/or applications may be executed to implement the functionalities of one or more components of the CAV parking system 100, including the CAV computer 150, the handheld device 130, the passenger's device 155, the CAV server 110, the parking system server 115, the smart parking ticket 140, and/or bank server 120. The software and/or applications may be executed to cause the computer system 600 to perform all or part of one or more procedures described with respect to the methods discussed herein. FIG. 6 provides a schematic illustration of one embodiment of a computer system 600 that can perform some or all of the steps of the methods provided by various embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605, or may otherwise be in communication, as appropriate. The hardware elements may include one or more processors 610, including without limitation one or more general-purpose processors (e.g., CPUs) and/or one or more special-purpose processors such as digital signal processing chips, graphics acceleration processors (e.g., GPUs), and/or the like; one or more input devices 615, which can include without limitation a mouse, a keyboard, a camera, a touchscreen, and/or the like; and one or more output devices 620, which can include without limitation a display device and/or the like.

The computer system 600 may further include and/or be in communication with one or more non-transitory storage devices 625, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 600 might also include a communication interface 630, which can include without limitation a modem, a network card (wireless or wired), an infrared communication device, a wireless communication device, and/or a chipset, and/or the like. The communication interface 630 may include one or more input and/or output communication interfaces to permit data to be exchanged with other computer systems and/or any other devices described herein.

The computer system 600 also can include software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, all or part of one or more procedures described with respect to the methods discussed herein, and/or methods described in the claims, might be implemented as code and/or instructions executable by a computer and/or a processor within a computer. In an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 625 described above. In some cases, the storage medium might be incorporated within a computer system, such as computer system 600. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 600 to perform methods in accordance with various embodiments of the technology. According to a set of embodiments, some or all of the procedures of such methods are performed by the computer system 600 in response to processor(s) 610 executing one or more sequences of one or more instructions, which might be incorporated into the operating system 640 and/or other code, such as an application program 645, contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 625. Volatile media include, without limitation, dynamic memory, such as the working memory 635.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communication interface 630 and/or components thereof generally will receive signals, and the bus 605 then might carry the signals and/or the data, instructions, etc. carried by the signals to the working memory 635, from which the processor(s) 610 retrieves and executes the instructions. The instructions received by the working memory 635 may optionally be stored on a non-transitory storage device 625 either before or after execution by the processor(s) 610.

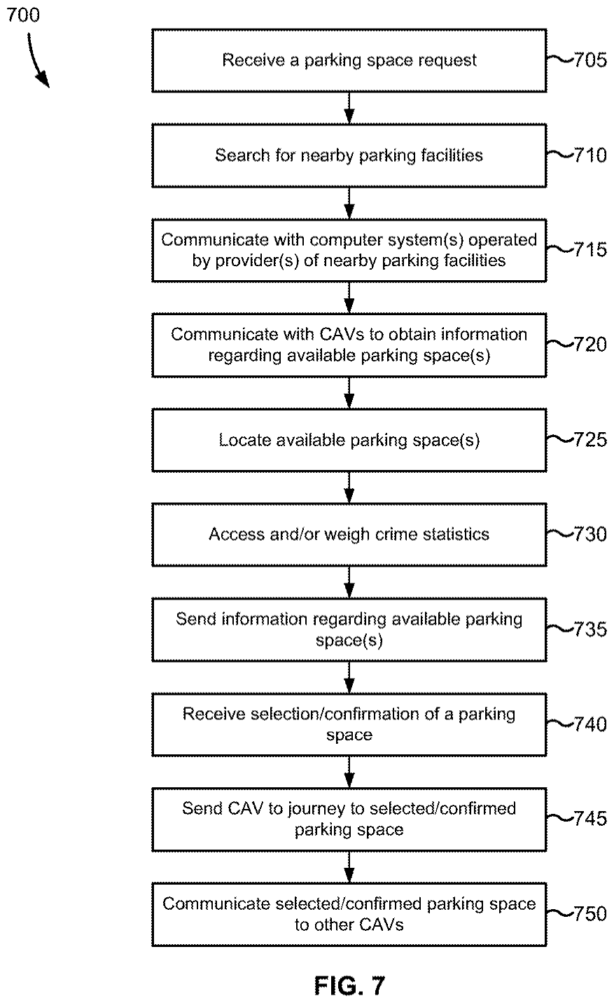

FIG. 7 is a flow diagram of a method 700 of locating a parking space for a CAV, according to an embodiment. Alternative embodiments may vary in function by combining, separating, or otherwise varying the functionality described in the blocks illustrated in FIG. 7. The functionality of one or more of the blocks illustrated in FIG. 7 may be performed by a parking service server (or similar device), such as the parking service server 115 described above. The parking service server may include software means, which may be executed by one or more processing units.

At block 705, method 700 may include receiving a parking space request to locate a nearby parking space for a CAV. The parking space request may be sent from a CAV in searching for a nearby parking space or from a device of a passenger or owner of the CAV. The parking space request may include information indicative of a location of the CAV.

At block 710, method 700 may include searching, based at least in part on the information indicative of the location of the CAV, one or more databases that may store information regarding nearby parking facilities, such as street parking, garages, parking lots, etc. In some embodiments, when searching for nearby parking facilities, method 700 may further include determining a zone within which nearby parking facilities may be searched. The zone may be determined based on the location of the CAV and a predetermined distance from the location of the CAV. In some embodiments, when searching for nearby parking facilities, method 700 may include determining a time that may be needed to travel from the current location to the parking facilities, which may take into account traffic conditions, time of the day, etc., and only parking facilities that may be reached within a predetermined period of time may be searched and/or located. The predetermined distance and/or period of time may be default values utilized by the parking service server or may be values specified by the owner or passengers of the CAV.

In some embodiments, method 700 may include, at block 715, communicating with computer systems operated or maintained by one or more providers of the parking facilities to locate available parking spaces. The computer systems may be configured to track or maintain information of available parking spaces. Alternatively or additionally, in some embodiments, method 700 may include, at block 720, receiving information regarding available parking spaces from CAVs in communication with the parking system server. The CAVs may detect various available parking spaces as described above, and communicate the location of these available spaces to the parking system server. At block 730, method 700 may include locating one or more available parking spaces at one or more of the nearby parking facilities.

In some embodiments, method 700 may further include, at block 730, accessing and/or weighing crime statistics when locating available parking spaces. For example, in some embodiments, method 700 may include receiving an indication of a level of tolerance for crime provided by a passenger or owner of the CAV, and determining a weight or importance of crime based on the indication received from the passenger or owner of the CAV. In some embodiments, method 700 may further include accessing one or more databases with crime statistics for locations relevant to the nearby parking facilities and/or the available parking spaces. The databases may be maintained by the parking service server or a law enforcement or other government entity. The crime statistics may indicate crime levels at certain streets, parking facilities, or other relevant locations to nearby parking. Method 700 may locate available parking spaces further based on the crime statistics and/or the weight or importance of crime.

At block 735, method 700 may include sending information regarding the located available parking spaces to a device of a passenger or owner of the CAV. The passenger or owner of the CAV may provide a selection of a parking space, if multiple parking spaces may be located and presented to the passenger or owner, or confirm the parking space when limited number of available parking spaces, such as only one parking space, may be located and presented.

At block 740, method 700 may include receiving the selection of the parking space from multiple available parking spaces or the confirmation of the parking space by the passenger or owner. In some embodiments, method 700 may simply select an available parking space without input from the passenger or owner of the CAV. For example, the parking service server may select the parking space for the CAV.

At block 745, method 700 may include sending the CAV to journey to the parking space, such as the parking space selected or confirmed by the passenger or owner of the CAV. In some embodiments, instructions including location of the parking space and/or travel route to the parking space may be sent directly to the CAV or may be sent to a CAV server, such as the CAV server 110 described herein, which may then send the instructions to the CAV to journey to the available parking space.

In some embodiments, method 700 may include, at block 750, “virtual booking” the parking space. For example, method 700 may include booking the available parking space for the CAV or assigning the available parking space to the CAV, and communicating to other CAVs (either directly or via the CAV server) the booking or assignment of the parking space. Thus, other CAVs may be prevented from occupying the parking space while the CAV makes its way to the parking space.

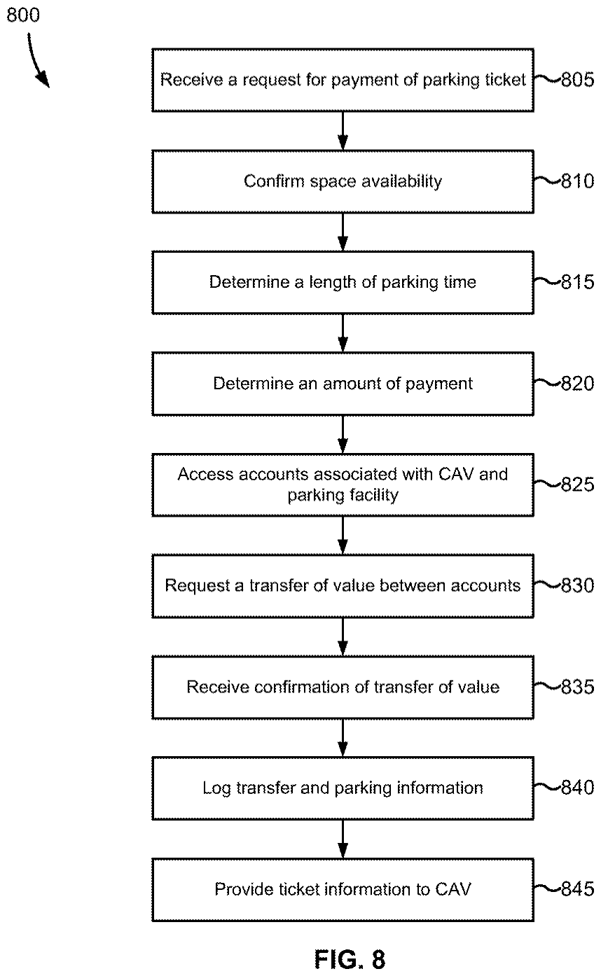

FIG. 8 is a flow diagram of a method 800 of providing a parking ticket to a CAV, according to an embodiment. Alternative embodiments may vary in function by combining, separating, or otherwise varying the functionality described in the blocks illustrated in FIG. 8. The functionality of one or more of the blocks illustrated in FIG. 8 may be performed by a parking service server (or similar device), such as the parking service server 115 described above. The parking service server may include software means, which may be executed by one or more processing units. The functionality of method 800 may begin when the CAV needs to obtain a parking ticket, such as when the CAV parks in an available parking space, which may be located using method 700. Thus, in some embodiments, method 800 may include part or all functionality of method 700.

At block 805, method 800 may include receiving a request for payment of a parking ticket to be issued to the CAV for parking at a parking space of a parking facility, such as the parking space located utilizing method 700. In some embodiments, the request for payment may include confirmation that the CAV has parked in the parking space. The request for payment and/or confirmation may be received by the parking service server from the CAV directly or from the CAV server which may relay the information it has received from the CAV to the parking service server.

At block 810, method 800 may include confirming space availability. In some embodiments, space availability may be confirmed by accessing a rule database to determine whether rules governing parking for the particular parking space allow the CAV to park there, and for how long. The rule database may be maintained on the parking system server and/or maintained on a separate server, which may be maintained by separate entity, such as a parking facility provider.

At block 815, method 800 may include determining a length of parking time. In some embodiments, the length of parking time may be determined by accessing parking rules governing a time limit for the parking space. As mentioned above, rule databases may be maintained on the parking service server and/or a separate server. In some embodiments, the length of parking time may be determined by accessing a schedule for the CAV maintained by a taxi service or a fleet owner and determine a time the CAV may be scheduled to leave the parking space based on, e.g., bookings for the CAV. In some embodiments, the length of parking time may be determined by receiving from the CAV an indication of an intended departure time or intended duration of parking. In some embodiments, such indication may be received from a device of the passenger or owner of the CAV. For example, the passenger's or owner's device may receive an user input indicating the intended duration of parking, and communicate such indication to the parking service server directly or communicate such indication to the CAV server, which may then relay the indication to the parking service server.

At block 820, method 800 may include determining an amount of payment for the requested parking ticket. For example, the amount of payment may be calculated based on parking rules and/or the determined length of parking time. In some embodiments, the payment may be requested and the amount of payment may be determined once the CAV has parked. In some embodiments, the payment may be requested retroactively, such as when the CAV is leaving the parking facility. For example, method 800 may include receiving a first indication from the CAV when the CAV enters the parking facility. The first indication indicates that the CAV has entered the parking facility. Method 800 may then include tracking a length of time that the CAV has parked at the parking facility. Method 800 may further include receiving a second indication from the CAV that the CAV is leaving the parking facility. The second indication thus may also serve a request for payment for the duration the CAV has parked. Method 800 may then include determining the amount of payment based on the tracked length of time and any governing parking rules.

At block 825, method 800 may include accessing a first account associated with the CAV and a second account associated with the parking facility. For example, the parking service server may maintain accounts associated with the owner or operator of the CAV, such as a passenger, taxi service, fleet owner, etc. The maintained accounts may include payment information, such as payment card number, expiration date, balance account, rewards/points account, etc., which may be used to pay for parking related to the CAV. The parking service server may also maintain accounts for the owner, operators, and/or other merchants associated with the various parking facilities. Method 800 may include identifying the particular account associated with the particular parking facility the CAV is parked.

At block 830, method 800 may include conducting a transfer of value, which may be money, credits, reward points, and the like, from the first account to the second account. In some embodiments, method 800 may include conducting the transfer of value by, at block 835, sending a request to a server, such as a bank server, requesting a money transfer from the first account associated with the CAV to the second account associated with the parking facility. For example, the parking service server may send information of both accounts to the server, which may then make the money transfer. Method 800 may then include, at block 835, receiving from the server a confirmation of the money transfer, and at block 840, logging the payment and other parking information. The parking service server may maintain a parking payments database and log the payment in the database. Other information related to the parking requested, e.g., parking starting and/or ending time, duration and/or amount paid for, identification information of the CAV, etc., may also be logged. The logged information may facilitate authentication of a parking ticket by a traffic warden as will be discussed below.

At block 845, method 800 may include sending ticket payment information to the CAV. The ticket payment information may be encrypted to help secure payment and/or ticket information. For example, in some embodiments, method 800 may further include sending by the parking service server an encrypted message to the CAV containing the ticket payment information, and/or providing by the parking service server an encryption key to the CAV. The CAV may then obtain the ticket information and display the ticket payment information and/or provide proof of payment using a smart parking ticket, such as the smart parking ticket 140 described herein.

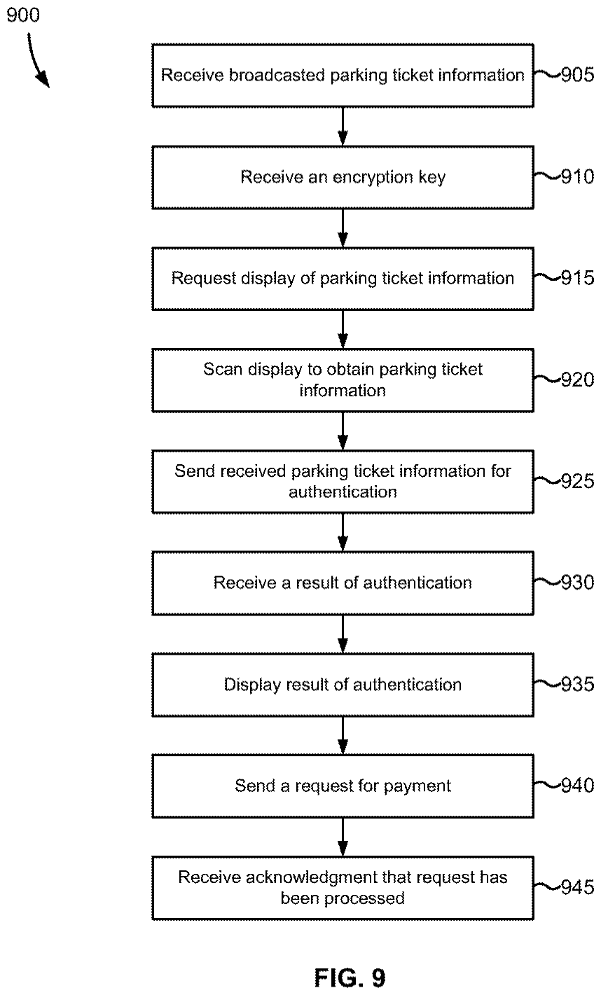

FIG. 9 is a flow diagram of a method 900 of authenticating a parking ticket, according to an embodiment. Alternative embodiments may vary in function by combining, separating, or otherwise varying the functionality described in the blocks illustrated in FIG. 9. The functionality of one or more of the blocks illustrated in FIG. 9 may be performed by a device operated by a traffic warden, such as the handheld device 130 described above. The handheld device may include software means, which may be executed by one or more processing units.

At block 905, method 900 may include receiving parking ticket information. In some embodiments, the parking ticket information may be received by the traffic warden's handheld device via wireless beacons broadcasted by a smart parking ticket, such as the smart parking ticket 140 described herein, incorporated in a CAV. In some embodiments, the parking ticket information may be received via Bluetooth low energy (BLE) beacons.

In some embodiments, the broadcasted ticket information may be encrypted to help ensure the ticket information remain secure. At block 910, method 900 may include receiving an encryption key from the parking service server for the received parking ticket information. The encrypted parking ticket information may then be accessed by the traffic warden using the handheld device.

In some embodiments, at block 915, method 900 may include communicating to the smart parking ticket to request a display of the smart parking ticket to be turned on to display visual information related to the parking ticket information. For example, the handheld device may be capable of communicating to the smart parking ticket and requesting the display of the smart parking ticket to be turned on. In some embodiments, the visual information that may be displayed may include relevant parking ticket information, such as amount of paid, remaining duration of parking, identification information of the CAV, etc.

In some embodiments, the visual information that may be displayed may include a scannable code, such as a QR code or other similar scannable code, that may be scanned using a camera of the traffic warden's handheld device. Method 900 may include, at block 920, scanning the scannable code to obtain the parking ticket information. In some embodiments, by scanning the displayed visual information, a link to payment may also be obtained, which may allow the traffic warden to request a payment, if needed. Other information, such as identification information of the CAV, a passenger and/or owner of the CAV, etc., may also be obtained by scanning the code displayed by the smart parking ticket. Obtaining ticket information via both the display and the transmitted wireless beacons may provide added layer of security against fraud as the ticket information obtained via the display may be compared with the information obtained via the wireless beacons.

At block 925, method 900 may further include sending the received parking ticket information to the parking system server for authentication. In some embodiments, after receiving the parking ticket information broadcasted by the smart parking ticket, the handheld device may send the received information to the parking service server, which can then authenticate the ticket. The information sent may include identification information of the CAV, such as a unique identifier of the CAV, aspect of the parking ticket information, such as amount paid, time of purchase, duration of parking ticket, etc. The parking service server may then verify the parking ticket information by, for example, checking the logged payment and/or parking information in its parking payment database. In some embodiments, information obtained from the display of the smart parking ticket may be alternatively or additionally sent to the parking service server for authentication. Such information may be obtained by scanning the visual information displayed by the smart parking ticket or may be input by the traffic warden into the handheld device of the traffic warden, which may then communicate the information to the parking service server.

At block 930, method 900 may include receiving a result of authentication from the parking system server. The result of authentication may indicate the ticket information is verified, or may indicate possible fraud, nonpayment, and/or other potential issues. At block 935, method 900 may include displaying the result of authentication on the handheld device to the traffic warden. In some embodiments, the parking ticket information may be displayed on the handheld device instead of or in addition to displaying the result of authentication. In some embodiments, the ticket information displayed on the handheld device of the traffic warden may be compared with the information displayed on the smart parking ticket to determine whether there are any issues with the parking ticket.

If the result of authentication indicates that the parking ticket information is unauthenticated, such as due to nonpayment or insufficient payment, at block 940, method 900 may include sending by the handheld device of the traffic warden a request for payment to the parking service server. The request for payment may include amount of payment to request, identification information of the CAV, information regarding the parking facility, and/or other information that may facilitate processing of the payment request. The identification information of the CAV may be obtained by scanning the scannable code, such as the QR code, displayed by the smart parking ticket 140 or may be obtained by receiving wireless beacons broadcast by the smart parking ticket.

Upon receipt of the request, the parking service server may then determine the accounts associated with the CAV and the parking facility based on the identification information of the CAV and/or the parking facility received. The parking service server may then conduct a transaction to transfer value from the account associated with the CAV to the account associated with a provider of the parking facility in a manner similar to that described above. Upon completion of the transaction, the parking service server may send an acknowledgment to the handheld device that the payment request has been processed. At block 945, method 900 may then include receiving from the parking system server the acknowledgment that the request for payment has been processed. In some embodiments, the parking service server may also sent the parking ticket information to the handheld device of the traffic warden and/or to the smart parking ticket to broadcast and/or display.

In some embodiments, the functionalities of blocks 940 and 945 may be performed without requesting authentication of the parking ticket information. For example, in some embodiments, the smart parking ticket may display nonpayment (e.g., due to disrupted connection when conducting payment when the CAV first parked) or expired payment. In such instances, and in other scenarios, the traffic warden may utilize the handheld device to initiate or generate a request for payment. In some embodiments, the smart parking ticket may display a timer indicating the duration it has been parked at the parking space. The traffic warden may send using the handheld device to the parking service server the duration the CAV has been parked at the parking space when sending the payment request. In some embodiments, the traffic warden may determine, based at least in part on the displayed timer, an amount of payment to request.

The above description discusses the present technology generally in the context of finding a parking space for a CAV, paying for a parking ticket, providing proof of payment by a smart parking ticket incorporated in the CAV, and/or authenticating ticket information provided by the smart parking ticket, and the like. It should be noted that the present technology is not intended to be limited to only parking-related applications. For example, the CAV may be tolled or charged for using the road while traveling on the road. The present technology may be similarly applicable to determining the appropriate route to take, paying for the toll or use charge, proving proof of payment, authenticating payment information, and/or other functionality that may be useful for road use charging. Further, the present technology may be applicable to refueling the CAV. The present technology may be particularly beneficial when the fueling may be conducted autonomously, such as by driving to a wireless charging station and the like. The present technology may then be utilized to determine which charging station to go to, facilitate payment of the fueling charge, providing and/or authenticating payment, and the like. The present technology may further taking into account costs associated with each of parking, road uses, and/or refueling to determine whether to park, to continue traveling, and/or to refuel when the CAV may not have any passengers. Instead of, or in addition to, the parking service server, the present technology may include a toll service server and/or a fuel service server that may communicate with the CAV to conduct payment for the toll charges and/to refueling charges, providing and authenticating proof of payment, etc. The CAV may use the smart parking ticket or another device incorporated in the CAV to provide the proof of payment when requested or needed.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups. As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A method of providing a parking ticket to a connected and autonomous vehicle (CAV), the method comprising:
receiving a parking space request to locate a nearby parking space for a CAV, wherein the parking space request comprises information indicative of a location of the CAV;
searching, based at least in part on the information indicative of the location of the CAV, a database containing information regarding nearby parking facilities having parking spaces;
locating at least one available parking space at at least one of the nearby parking facilities;
sending the CAV to journey to one parking space of the at least one available parking space;
receiving a request for payment of a parking ticket to be issued to the CAV for parking at the one parking space;
determining an amount of payment for the requested parking ticket;
accessing a first account associated with the CAV and a second account associated with the parking facility having the one parking space where the CAV is parked;
conducting a transfer of value from the first account to the second account; and
sending ticket payment information to the CAV.

2. The method of claim 1, wherein sending ticket payment information to the CAV further comprising:
sending an encrypted message to the CAV, wherein the encrypted message comprises the ticket payment information; and
providing an encryption key to the CAV.

3. The method of claim 1, further comprising determining a length of parking time based on one or more of the following:
accessing parking rules governing a time limit for a parking space of the parking facility;
receiving from the CAV or a device of a passenger or owner of the CAV an indication of a duration of parking; or
accessing a schedule for the CAV maintained by a taxi service or a fleet owner.

4. The method of claim 1, wherein receiving the request for payment for the parking ticket comprises:
receive a first indication from the CAV that the CAV has entered the parking facility;
track a length of time that the CAV has parked at the parking facility; and
receive a second indication from the CAV that the CAV is leaving the parking facility.

5. The method of claim 4, wherein determining the amount of payment for the requested parking ticket comprises determining the amount of payment for the requested parking ticket based at least in part on the tracked length of time.

6. The method of claim 1, wherein locating the at least one available parking space comprises at least one of:
communicating with a computer system operated by a provider of the at least one of the parking facilities, wherein the computer system is configured to maintain information of available parking spaces; or
receiving information regarding available parking spaces from a plurality of CAVs configured to detect available parking spaces.

7. The method of claim 1, further comprises:
sending information regarding the located at least one available parking space to a device of a passenger or owner of the CAV; and
receiving, from the device of the passenger or owner of the CAV, a selection of a parking space from the at least one available parking space or a confirmation of the at least one available parking space by the passenger or owner;
wherein sending the CAV to journey to the one parking space comprises sending the CAV to journey to the parking space selected or confirmed by the passenger or owner.

8. The method of claim 1, further comprising:
receiving an indication of a level of tolerance for crime provided by a passenger or owner of the CAV;
determining a weight or importance of crime based on the indication received from the passenger or owner of the CAV; and
accessing a database with crime statistics for locations relevant to the nearby parking facilities;
wherein the at least one available parking space is located based on at least one of the crime statistics or the weight or importance of crime.

9. The method of claim 1, further comprising:
assigning the at least one available parking space to the CAV; and
communicating to other CAVs the assignment of the at least one available parking space to the CAV.

10. The method of claim 1, wherein conducting the transfer of value comprises:
sending a request to a server requesting a transfer of value from the first account to the second account; and
receiving from the server a confirmation of the transfer of value.

11. A parking system server, comprising:
a communication interface;
a memory; and
a processing unit communicatively coupled with the memory and the communication interface and configured to cause the parking service server to:
receive a parking space request to locate a nearby parking space for a CAV, wherein the parking space request comprises information indicative of a location of the CAV;
search, based on the information indicative of the location of the CAV, information regarding nearby parking facilities having parking spaces; and
locate at least one available parking space at at least one of the nearby parking facilities;
send the CAV to journey to one parking space of the at least one available parking space;
receive a request for payment of a parking ticket to be issued to the CAV for parking at the one parking space;
determine an amount of payment for the requested parking ticket;
access a first account associated with the CAV and a second account associated with the parking facility having the one parking space where the CAV is parked;
conduct a transfer of value from the first account to the second account; and
send ticket payment information to the CAV.

12. The parking service server of claim 11, wherein the processing unit is further configured to cause the parking service server to send ticket payment information to the CAV by:
sending an encrypted message to the CAV, wherein the encrypted message comprises the ticket payment information; and
providing an encryption key to the CAV.

13. The parking service server of claim 11, wherein the processing unit is further configured to determine a length of parking time based on one or more of the following:
accessing parking rules governing a time limit for a parking space of the parking facility;
receiving from the CAV or a device of a passenger or owner of the CAV an indication of a duration of parking; or
accessing a schedule for the CAV maintained by a taxi service or a fleet owner.

14. The parking service server of claim 11, wherein the processing unit is configured to cause the parking service server to receive the request for payment for the parking ticket for the CAV by causing the parking service server to:
receive a first indication from the CAV that the CAV has entered the parking facility;
track a length of time that the CAV has parked at the parking facility; and
receive a second indication from the CAV that the CAV is leaving the parking facility.

15. The parking service server of claim 14, wherein the processing unit is configured to cause the parking service server to determine the amount of payment for the requested parking ticket based at least in part on the tracked length of time.

16. The parking service server of claim 11, wherein the processing unit is further configured to cause the parking service server to locate the at least one available parking space by at least one of:
communicating with a computer system operated by the at least one of the parking facilities, wherein the computer system is configured to maintain information of available parking spaces; or
receiving information regarding available parking spaces from a plurality of CAVs configured to detect available parking spaces.

17. The parking service server of claim 11, wherein the processing unit is configured to cause the parking service server to:
send information regarding the located at least one available parking space to a device of a passenger or owner of the CAV;
receive, from the device of the passenger or owner of the CAV, a selection of a parking space from the at least one available parking space or a confirmation of the at least one available parking space by the passenger or owner; and
sending the CAV to journey to the one parking space by sending the CAV to journey to the parking space selected or confirmed by the passenger or owner.

18. The parking service server of claim 11, wherein the processing unit is configured to cause the parking service server to:
receive an indication of a level of tolerance for crime provided by a passenger or owner of the CAV;
determine a weight or importance of crime based on the indication received from the passenger or owner of the CAV;
access a database with crime statistics for locations relevant to the nearby parking facilities; and
locate the at least one available parking space based on at least one of the crime statistics or the weight or importance of crime.

19. The parking service server of claim 11, wherein the processing unit is configured to cause the parking service server to:
assign the at least one available parking space to the CAV; and
communicate to other CAVs the assignment of the at least one available parking space to the CAV.

20. The parking service server of claim 11, wherein the processing unit is configured to cause the parking service server to conduct a transfer of value from the first account to the second account by:
sending a request to a server requesting a transfer of value from the first account to the second account; and
receiving from the server a confirmation of the transfer of value.
